(19) United States
(12) Patent Application Publication
(10) Pub. No.: US 2026/0192933 A1
(43) Pub. Date: Jul. 9, 2026

(54) IMPROVED HYBRID TURBOPROP ENGINE FOR AIRCRAFT

(71) Applicant: SAFRAN HELICOPTER ENGINES, Bordes (FR)

(72) Inventors: Lucie Stéphanie APOSTIN, Moissy-Cramayel (FR); Loïs Pierre Denis VIVE, Moissy-Cramayel (FR); Christian Omer Henri SARRAT, Moissy-Cramayel (FR)

(73) Assignee: SAFRAN HELICOPTER ENGINES, Bordes (FR)

(21) Appl. No.: 19/133,021

(22) PCT Filed: Nov. 22, 2023
(86) PCT No.: PCT/FR2023/051840

§ 371 Date: May 27, 2025

(30) Foreign Application Priority Data
Nov. 28, 2022 (FR) FR2212427

(51) Int. Cl. B64D 31/14; B64D 27/33; F02C 7/32

(52) U.S. Cl. CPC B64D 31/14; B64D 27/33; F02C 7/32

(57) ABSTRACT

A hybrid turboprop for an aircraft, including a gas generator carried by a generator shaft, a free turbine carried by a turbine shaft and driven in rotation by a gas stream generated by the gas generator, the turbine shaft being engaged with a main rotor via a transmission unit including a first free wheel oriented such that the main rotor cannot drive the free turbine, a reversible electric machine engaged with the main rotor via the transmission unit to drive the main rotor during electric or hybrid operation, the turboprop including a single oil pump engaged with the transmission unit so as to be selectively driven by the turbine shaft or by the electric machine depending on the operating mode.

### TECHNICAL FIELD

The present invention relates to the field of hybrid aircrafts, comprising a turboprop for a propeller plane. Particularly, the invention relates to a hybrid turboprop for an aircraft, and a hybrid aircraft comprising such a turboprop.

### PRIOR ART

As is known, a plane turboprop includes a gas turbine having a gas generator and a free turbine driven in rotation by the gas stream generated by the gas generator. Furthermore, in a hybrid aircraft, the turboprop generally comprises an electric machine coupled to the propeller, so as to ensure fully electric (i.e., 100% electric) or hybrid operation. By “hybrid” or “parallel hybrid,” it is meant in particular that the power source driving the pusher propeller may be the turbine engine, the electric motor(s), or a combination of the two depending on the desired operating modes.

Traditionally, the gas generator includes at least one compressor and one turbine coupled in rotation. The operating principle is as follows: the fresh air entering the gas turbine is compressed due to the rotation of the compressor before being sent to a combustion chamber where it is mixed with fuel. The burnt gases resulting from the combustion are then discharged at high speed. A first expansion then occurs in the gas generator turbine, during which the latter extracts the energy necessary to drive the compressor. The gas generator turbine does not absorb all the kinetic energy of the burnt gases and the excess kinetic energy corresponds to the gas stream generated by the gas generator. The latter therefore provides kinetic energy to the free turbine so that a second expansion occurs in the free turbine which transforms this kinetic energy into mechanical energy in order to drive a receiving member, such as a turboprop propeller.

Furthermore, in a traditional turboprop, separate transmission units are generally used, in particular a power gearbox known by the acronym “PGB” allowing the transmission of power from the free turbine to the propeller, and an accessory gearbox known by the acronym “AGB” allowing the transmission of power from the gas generator to the accessories.

These architectures in which the “free turbine” and “gas generator” axes are distinct and not engaged with each other do not allow for electric, thermal or hybrid propulsion, while optimally meeting safety requirements, and do not allow for the full potential of the introduction of high hybridization powers, from a functional point of view. Furthermore, in these turboprop architectures, the layout of the members dedicated to the lubrication and the mass of the assembly are not optimal.

There is therefore a need for an improved architecture that addresses at least part of the aforementioned drawbacks.

### DISCLOSURE OF THE INVENTION

The present disclosure relates to a hybrid turboprop for an aircraft, comprising a gas generator carried by a generator shaft, a free turbine carried by a turbine shaft and driven in rotation by a gas stream generated by the gas generator, the turbine shaft being engaged with a main rotor via a transmission unit comprising a first free wheel oriented such that the main rotor cannot drive the free turbine, a reversible electric machine able to be engaged with the main rotor via the transmission unit to drive the main rotor during an electric or hybrid operating mode, the turboprop comprising a single oil pump engaged with the transmission unit so as to be selectively driven by the turbine shaft or by the electric machine depending on the operating mode of the turboprop.

In the present disclosure, by “free wheel” it is meant a device comprising a hub and a peripheral ring gear rotatably mounted on the hub. The hub can drive in rotation the peripheral ring gear but not vice versa. Also, the hub can only drive the ring gear when the hub rotates in a predetermined direction, which will be called “engagement direction”. Otherwise, the hub and the peripheral ring gear rotate freely relative to each other. In this case, the free wheels are activated when the hub of the free wheel drives in rotation the peripheral ring gear and, conversely, the free wheels are deactivated when the hub of the free wheel does not drive in rotation the peripheral ring gear. One advantage of the free wheel is that it does not need to be electronically or mechanically controlled by an external operator.

The main rotor may comprise a propeller of the aircraft, in particular a plane, allowing its propulsion, the propeller then being disposed at one end of the turboprop, preferably at the front end of the turboprop when considering a normal direction of movement of the aircraft. The main rotor is thus movable about an axis of rotation, which may correspond to the main axis of the turboprop, or be radially offset relative to the latter.

Moreover, by “engaged with,” it is meant that a member is mechanically linked to another member, directly or indirectly. In the present disclosure, in particular, the end of the turbine shaft is mechanically linked to the main rotor indirectly via the transmission unit.

The reversible electric machine, when operating in motor mode, provides the propulsive energy to the main rotor. Particularly, this architecture allows for fully thermal (100% thermal) operation in which the free turbine drives the main rotor via the transmission unit, fully electric (100% electric) operation on the ground or in flight in which the reversible electric machine drives the main rotor via the transmission unit, and a hybrid operation in which the main rotor is driven by both the reversible electric machine and by the free turbine.

Moreover, according to this architecture, the oil pump for circulating the lubricating oil intended to lubricate the various bearings of the turboprop is engaged with the transmission unit, and can therefore be driven selectively by the turbine shaft in the case of 100% thermal or hybrid operation, or by the electric machine in the case of 100% electric or hybrid operation.

This architecture therefore allows the use of a single oil pump capable of lubricating the bearings of the transmission unit, and also the bearings of the accessory gearbox engaged with the generator shaft. In other words, being able to select the source (electric machine and/or turbine shaft) for driving the single oil pump depending on the operating mode, makes it possible to optimize the members dedicated to lubrication, thus limiting the mass of the assembly and to improve the reliability of the device.

In some embodiments, the electric machine is engaged with the main rotor via a second free wheel of the transmission unit, the second free wheel being oriented such that the main rotor cannot drive the electric machine.

In other words, the second free wheel allows the driving of the main rotor, in particular of the propeller, by the electric machine, but not vice versa. Thus, according to this configuration, a free wheel (the first and the second free wheel) is located between each power source (free turbine and electric machine) and the main rotor, which is the sole receiver. It is therefore possible to choose the (thermal and/or electric) power source independently of each other.

In some embodiments, the electric machine is able to be engaged with the main rotor via a reversible coupling means movable between a coupling position in which the electric machine can drive the main rotor during operation in motor mode or be driven by the main rotor or the free turbine during operation in generator mode, and a decoupling position in which the electric machine is decoupled from the main rotor.

Unlike the free wheel, which authorizes a transfer of power only in the direction from the electric machine towards the main rotor, the coupling means, when activated, i.e. in the coupling position, allows mechanically linking the electric machine and the main rotor via the transmission unit, such that the electric machine can drive the main rotor, and vice versa. Moreover, during 100% thermal operation, the coupling means in the decoupling position makes it possible to prevent the driving of the electric machine by the free turbine.

This configuration makes it possible to increase the number of functional modes achievable by this architecture. Particularly, in addition to the 100% electric or hybrid operating modes when the reversible electric machine is operating in motor mode, the reversible electric machine can be driven by the main rotor or the free turbine during an operation in generator mode, so as to produce electricity in order to provide it to various aircraft equipment, or to recharge the high-voltage battery.

This generation can take place in flight or on the ground. The electric machine is then driven by the free turbine, in other words by the heat engine which also drives the main rotor. Furthermore, the electrical generation can also be carried out during an operating mode called “wind turbine” operating mode, in which the main rotor, for example the propeller, is driven in rotation by the forward motion of the aircraft and drives the electric machine.

In some embodiments, the reversible coupling means is a clutch. A clutch has the advantage of being remotely pilotable, for example via a monitoring unit, and can in particular move from the coupling position to the decoupling position at any time in flight. The turboprop may comprise a synchronization device for achieving this passage from the coupling position to the decoupling position.

In some embodiments, the turboprop comprises a coupling shaft having a first end engaged with the transmission unit and a second end engaged with the generator shaft. The second end may be engaged with the generator shaft via the gears of an accessory gearbox.

Unlike the conventional turboprop configurations, in which the free turbine and the gas generator are separate, the coupling shaft physically links the generator shaft to the transmission unit, and therefore to the turbine shaft, via the transmission unit. It should be noted that the coupling shaft is preferably flexible to compensate for any offset in the alignment of these various members.

It is therefore understood that this configuration allows the electric machine to drive the generator shaft, and therefore the gas generator, via the coupling shaft. It is thus possible to use the reversible electric machine to start the gas generator. This configuration eliminates the need for a starter, which is usually required for the gas generator start-up phases. In other words, according to this embodiment, the turboprop comprises a single electric machine, which makes it possible to lighten and simplify the device. This reversible electric machine is a high-power electric machine, which can therefore be used in motor mode to drive the main rotor, and also for starting the gas generator.

By “high power” it is meant that, to perform these functions, the electric machine must be dimensioned to a power much higher than that of the generators/starters commonly used, typically one or several hundred kilowatts, instead of about ten kilowatts.

Furthermore, this architecture allows for an operating mode in which the main rotor is blocked, the gas generator operating alone to drive the accessories linked to it. Indeed, the coupling shaft engaged with the electric machine and the transmission unit allows driving the oil pump engaged with the transmission unit, without the need for a second oil pump linked to the gas generator, which therefore makes it possible to optimize the members dedicated to lubrication, and to limit the mass of the device.

In some embodiments, the coupling shaft comprises a coupling free wheel oriented such that the gas generator cannot drive the electric machine.

Although the presence of the coupling free wheel on the coupling shaft does not allow achieving the functional mode in which the main rotor is blocked and the gas generator alone drives the accessories linked to it (the gas generator cannot drive the oil pump due to the presence of the free wheel), this coupling free wheel makes it possible to prevent the gas generator from driving the electric machine when this is not desired, in particular after the start-up phase or during 100% thermal or hybrid operation.

Particularly, during a start-up phase using the reversible electric machine, when the gas generator becomes autonomous (approximately 50% of its nominal speed), its rotation speed becoming higher than that of the electric machine, the free wheel prevents the driving of the electric machine by the generator shaft. It will also be noted that during the start-up phase by the electric machine, the reversible coupling means, for example the clutch, is in the decoupling position such that the electric machine is used entirely for starting the gas generator. The oil pump is then driven by the turbine shaft during start-up.

In some embodiments, the second end of the coupling shaft is engaged with the generator shaft via a safety disconnection means configured to allow disconnection of the coupling shaft with the generator shaft in case of partial or total blockage of the gas generator.

The safety disconnection means, disposed between the coupling free wheel and the gas generator, makes it possible to avoid, by disconnecting the coupling shaft and the generator shaft, a situation in which the rotation of the electric machine operating in motor mode to drive the main rotor is hindered by the resistance generated by the partially or totally blocked gas generator. The electric machine can therefore perform its function of driving the main rotor in case of engine failure, which makes it possible to improve the safety of the device. The safety disconnection means may be an active or passive system, such as for example a weak section.

In some embodiments, the turboprop comprises a coupling shaft having a first end engaged with the transmission unit, and a second end engaged with the generator shaft, the coupling shaft comprising a coupling free wheel oriented such that the gas generator cannot drive the electric machine, the second free wheel being configured to be activated when the electric machine rotates in a first direction of rotation, and the coupling free wheel being configured to be activated when the electric machine rotates in a second direction of rotation opposite to the first direction of rotation.

According to this embodiment, the reversible electric machine is engaged with the transmission unit via the second free wheel, and with the gas generator via the coupling free wheel. It is understood that the second free wheel and the coupling free wheel are mounted in opposition. By “mounted in opposition”, it is understood that the second free wheel can transmit a rotation torque coming from the electric machine towards the main rotor, but not vice versa, while the coupling free wheel can transmit a rotation torque from the electric machine to the gas generator, but not vice versa.

Furthermore, according to this embodiment, the reversible electric machine can be used in one direction of rotation (for example clockwise direction) to be mechanically coupled to the gas generator (the electric machine then being decoupled from the main rotor), and in the other direction of rotation (for example counterclockwise direction) to be mechanically coupled to the main rotor (the electric machine then being decoupled from the gas generator).

Particularly, the electric machine rotating in the second direction of rotation allows the coupling with the gas generator in order to start the latter on the ground. Furthermore, the electric machine rotating in the first direction of rotation allows an operation in 100% electric or hybrid motor mode.

This configuration eliminates the need for a reversible coupling means such as a clutch, which is a complex device. Conversely, free wheels have the advantage of not needing to be controlled electronically or mechanically by an external operator. The free wheel also has significant reliability. Although this configuration does not allow the use of the electric machine in generator mode, it nevertheless improves the simplicity and reliability of the device, the use of a safety disconnection means as described above, such as a weak section, being no longer necessary.

In some embodiments, the reversible coupling means is a first reversible coupling means, the second end of the coupling shaft being engaged with the generator shaft via a second reversible coupling means movable between a coupling position in which the electric machine and the gas generator are coupled, and a decoupling position in which the electric machine and the gas generator are decoupled.

The first and second reversible coupling means may be clutches remotely pilotable via a monitoring unit, for example. It is thus possible to pilot the positions of the clutches according to the operating phases of the turboprop. In the start-up phase for example, the first coupling means (first clutch) is placed in the decoupling position and the second coupling means (second clutch) is placed in the coupling position. Conversely, during 100% electric or hybrid operation, the first clutch is placed in the coupling position and the second clutch is placed in the decoupling position.

This configuration makes it possible to perform a large number of functions, such as the generation of electricity by the electric machine by placing the first clutch in the coupling position, or the driving of the oil pump by the gas generator via the coupling shaft, by placing the coupling free wheel in the coupling position.

In some embodiments, the generator shaft is engaged with an accessory gearbox distinct from the transmission unit, the second end of the coupling shaft being engaged with the accessory gearbox.

The present disclosure also relates to an aircraft comprising a hybrid turboprop according to any one of the preceding embodiments, the aircraft being a propeller plane.

### BRIEF DESCRIPTION OF THE DRAWINGS

The invention and its advantages will be better understood upon reading the detailed description given below of different embodiments of the invention given as non-limiting examples. This description refers to the appended pages of figures, in which:

FIG. 1 represents a sectional view of a turboprop for a hybrid aircraft according to the invention,

FIG. 2 schematically represents the turboprop of FIG. 1 according to a first embodiment,

FIG. 3 schematically represents the turboprop of FIG. 1 according to a second embodiment,

FIG. 4 schematically represents the turboprop of FIG. 1 according to a third embodiment,

FIG. 5 schematically represents a detailed view of the turboprop according to the third embodiment,

FIG. 6 schematically represents the turboprop of FIG. 1 according to a fourth embodiment,

FIG. 7 schematically represents the turboprop of FIG. 1 according to a fifth embodiment,

FIGS. 8A and 8B schematically represent the turboprop of FIG. 1 according to a first operating mode of the third and fourth embodiments respectively,

FIGS. 9A and 9B schematically represent the turboprop of FIG. 1 according to a second operating mode of the third and fourth embodiments respectively,

FIGS. 10A and 10B schematically represent the turboprop of FIG. 1 according to a third operating mode of the third and fourth embodiments respectively,

FIGS. 11A and 11B schematically represent the turboprop of FIG. 1 according to a fourth operating mode of the third and fourth embodiments respectively,

FIG. 12 schematically represents the turboprop of FIG. 1 according to a fifth operating mode of the third embodiment,

FIG. 13 schematically represents the turboprop of FIG. 1 according to a sixth operating mode of the third embodiment.

### DESCRIPTION OF THE EMBODIMENTS

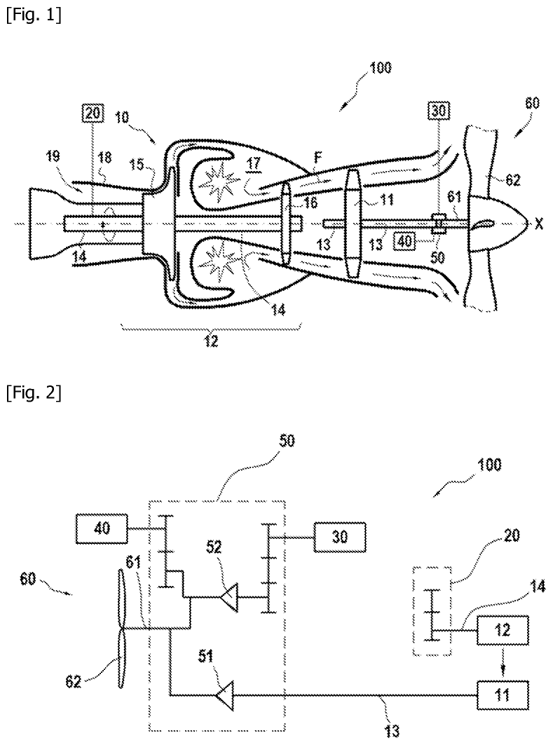

An architecture of a turboprop 100 according to different embodiments of the invention will be described in the remainder of the description, with reference to FIGS. 1 to 13.

FIG. 1 schematically represents a turboprop 100 of an aircraft, driving in rotation the main rotor 60 of a plane comprising a rotor axis 61 carrying a propeller 62. The turboprop 100 comprises a gas turbine 10 having a gas generator 12 and a free turbine 11 able to be driven in rotation by a gas stream generated by the gas generator 12.

The free turbine 11 is mounted on a turbine shaft 13 which transmits the rotational movement to the main rotor 60 via a transmission unit 50. One end of the turbine shaft 13 is engaged with the transmission unit 50, the other end facing the generator shaft 14 described below, by being uncoupled from the latter.

The gas generator 12 includes a rotary generator shaft 14 on which are mounted at least one centrifugal compressor 15 and at least one turbine 16, as well as a combustion chamber 17 disposed axially between the compressor 15 and the turbine 16 when considering the gas generator 12 along the axial direction of the generator shaft 14. The gas turbine 10 has a casing 18 provided with an air inlet 19 through which fresh air enters the gas generator 12. After its intake into the enclosure of the gas generator 12, the fresh air is compressed by the compressor 15 which discharges it towards the inlet of the combustion chamber 17 in which it is mixed with fuel. The combustion taking place in the combustion chamber 17 causes the discharge of the burnt gases at high speed towards the turbine 16, which has the effect of driving in rotation the shaft 14 of the gas generator 12 and, consequently, the compressor 15. The rotation speed of the shaft 14 of the gas generator 12 is determined by the fuel flow rate entering the combustion chamber 17.

Despite the extraction of kinetic energy by the turbine 16, the gas stream leaving the gas generator 12 has significant kinetic energy. As understood from FIG. 1, the gas stream F is directed towards the free turbine 11 which has the effect of causing an expansion in the free turbine 11 leading to the rotation of the turbine wheel and of the turbine shaft 13.

A reversible electric machine 30 (hereinafter simply referred to as “electric machine 30”) is engaged with the transmission unit 50, and includes an electric motor able to reversibly operate as an electric generator. The electric machine 30 can thus, according to the embodiments described below, provide power to the main rotor 60 by operating as a motor mode, or draw mechanical power from the main rotor 60 by operating as a generator mode. The electric machine 30 is a high-power electric machine (one to several hundred kilowatts).

The rear part of the turboprop 100, in other words the upstream part comprising the air inlet 19, comprises an accessory gearbox 20, known by the acronym “AGB”, engaged with the generator shaft 14. This accessory gearbox 20 comprises different equipment, depending on the chosen application.

The turboprop 100 further comprises a single oil pump 40 engaged with the transmission unit 50, the oil pump 40 thus being able to be driven by the turbine shaft 13 and/or the electric machine 30.

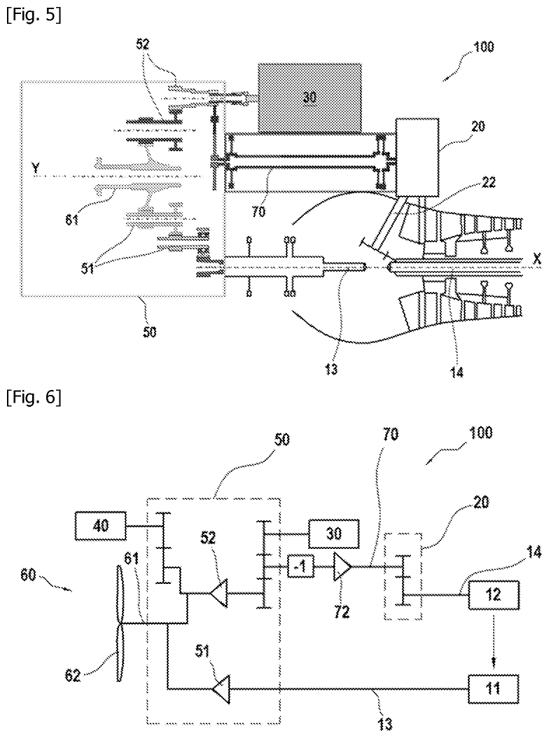

It will be noted that in the example represented in FIG. 1, all of the equipment, in particular the gas generator 12, the free turbine 11, the transmission unit 50 and the main rotor 60, are all coaxial and centered on the same main axis X. This arrangement is however not limiting, the invention applying to configurations in which the rotor axis 61 is radially offset relative to the main axis X of the turboprop, as illustrated in FIG. 5 described later in the description.

Different embodiments are described below with reference to FIGS. 2 to 13.

It will be generally noted that, for the sake of clarity, the following figures schematically represent in a functional and simplified manner the different operating modes of the device, without representing all the details of the elements constituting the turboprop 100 and the different power transmission members. Particularly, the pinions and possible speed ratios are not represented.

FIG. 2 represents an architecture according to a first embodiment, in which the turbine shaft 13 is engaged with the main rotor 60 via a first free wheel 51 of the transmission unit 50.

The first free wheel 51 is mounted such that the rotation of the turbine shaft 13 can drive in rotation the main rotor 60 when the turboprop is operating in 100% thermal or hybrid mode (first free wheel 51 activated) but that, on the contrary, the rotation of the main rotor 60 cannot drive in rotation the turbine shaft 13 (first free wheel 51 deactivated). In other words, the first free wheel 51 can transfer a rotation torque only in the direction of the turbine shaft 13 towards the main rotor 60, and not vice versa.

Moreover, according to this embodiment, the electric machine 30 is engaged with the main rotor 60 via a second free wheel 52 of the transmission unit 50.

The second free wheel 52 is mounted such that the rotation of the electric machine 30 can drive in rotation the main rotor 60 when the reversible electric machine 30 in operating as an electric motor (second free wheel 52 activated) but that, on the contrary, the rotation of the main rotor 60 cannot drive in rotation the electric machine 30 (second free wheel 52 deactivated). In other words, the second free wheel 52 can transfer a rotation torque only in the direction of the electric machine 30 towards the main rotor 60, and not vice versa.

Thus, the rotation of the electric machine 30 is able to drive in rotation the rotor axis 61 of the main rotor 60 when the turboprop 100 is operating in 100% electric or hybrid mode.

Moreover, when the turboprop 100 is operating in 100% electric mode in which only the electric machine 30 provides power to the main rotor 60 via the transmission unit 50 (gas generator 12 and free turbine 11 stopped), the electric machine 30 also drives the single oil pump 40 via the transmission unit 50.

Similarly, when the turboprop 100 is operating in 100% thermal mode in which only the free turbine 11 (driven by the gas generator 12) provides power to the main rotor 60 via the transmission unit 50 (electric machine 30 stopped), the free turbine 11 also drives the single oil pump 40 via the transmission unit 50.

When the turboprop 100 is operating in hybrid (thermal and electric) mode in which the main rotor 60 is driven by both the free turbine 11 and the electric machine 30, the oil pump 40 is driven by the free turbine 11 and/or the electric machine 30.

It will be noted that according to this embodiment, a starter-type electric machine, of lower power than the electric machine 30, is necessary for the start-up phases of the gas generator 12.

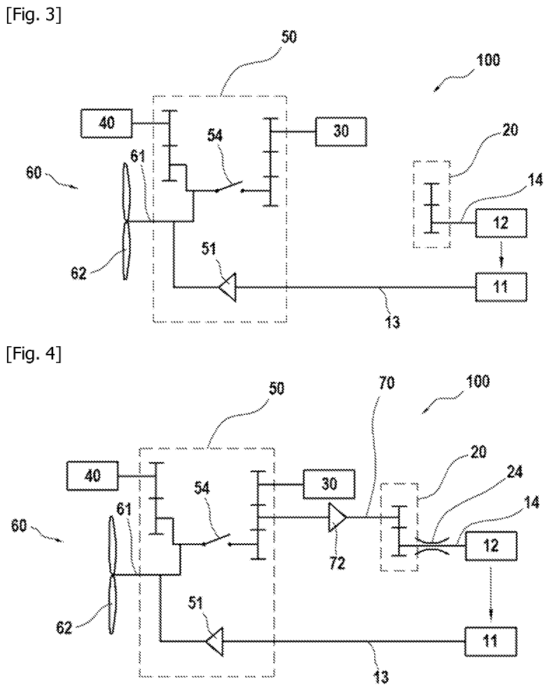

FIG. 3 represents an architecture according to a second embodiment, which differs from the first embodiment in that the second free wheel 52 of the transmission unit 50 is replaced by a reversible coupling means. In this example, the reversible coupling means is a first clutch 54. This example is not limiting, the reversible coupling means being able to be a manually removable connector, less technically complex than the clutch. The clutch 54, however, has the advantage of being able to be piloted remotely, via a control unit for example (not represented), including in flight.

The clutch 54 is movable between a coupling position (or “closed clutch”, or “clutch position”) in which the electric machine 30 is mechanically linked to the rotor axis 61 via the transmission unit 50 and can drive the main rotor 60 during an operation in motor mode, or be driven by the main rotor 60 or the free turbine 11 during an operation in generator mode, and a decoupling position (or “open clutch”, or “disengaged position”) which is the position represented in FIG. 3, in which the electric machine 30 is decoupled from the main rotor 60.

Unlike the first embodiment comprising the second free wheel 52, the clutch 54 makes it possible, when it is closed, i.e. in the coupling position, to mechanically link the electric machine 30 and the main rotor 60, such that the electric machine 30 can drive the main rotor 60, and vice versa. Moreover, during 100% thermal operation, the clutch 54 in the decoupling position makes it possible to prevent the driving of the electric machine 30 by the free turbine 11.

This configuration allows the electric machine 30, in addition to the motor mode during the 100% electric or hybrid operations described above, to operate in generator mode by being driven by the main rotor 60, so as to produce electricity, on the ground or in flight, to provide this electricity to different equipment of the aircraft, or to recharge the high-voltage battery.

FIGS. 4 and 5 represent an architecture according to a third embodiment, which differs from the second embodiment in that the turboprop 100 comprises a coupling shaft 70 having a first end engaged with the transmission unit 50, and a second end engaged with the accessory gearbox 20 and consequently with the generator shaft 14. In other words, according to this embodiment, the transmission unit 50 and the accessory gearbox 20 are physically linked to each other. The coupling shaft 70 is preferably flexible to compensate for any offset in the alignment between the transmission unit 50 and the accessory gearbox 20.

FIG. 5 represents a detailed view of the turboprop 100 according to the third embodiment, certain equipment being moreover hidden, such as the free turbine 11, the main rotor 60, the oil pump 40 or any free wheels. Particularly, FIG. 5 represents in detail the running gear comprising the various wheels 51, 52, possibly free wheels, engaged with each other, that the transmission unit 50 includes. It will be noted that in this example, the axis of rotation Y of the main rotor 60, in other words the rotor axis 61, is radially offset relative to the main axis X of the turboprop 100, the latter being schematically represented in a simplified manner. This arrangement facilitates the physical connection between the transmission unit 50 and the accessory gearbox 20 via the coupling shaft 70.

According to this embodiment, the coupling shaft 70 may comprise a coupling free wheel 72 oriented such that the gas generator 12 cannot drive the transmission unit 50, nor the electric machine 30, via the coupling shaft 70.

More specifically, the coupling free wheel 72 is mounted such that the rotation of the electric machine 30 can drive in rotation the gas generator 12 via the transmission unit 50 and the coupling shaft 70 when the reversible electric machine 30 is operating in electric motor mode (coupling free wheel 72 activated) towards the gas generator 12, but that on the contrary, the rotation of the gas generator 12 cannot drive in rotation the electric machine 30 (coupling free wheel 72 deactivated). In other words, the coupling free wheel 72 can transfer a rotation torque only in the direction of the electric machine 30 towards the gas generator 12, and not vice versa.

According to one modified example of this embodiment, the coupling free wheel 72 could be absent. This architecture would allow an operating mode in which the main rotor 60 is blocked, the gas generator 12 operating alone to drive the accessories of the accessory gearbox 20, the electric machine 30 being moreover stopped. Indeed, the coupling shaft 70 engaged with the transmission unit 50 makes it possible to drive the oil pump 40 engaged with the transmission unit 50, without the need for a second oil pump linked to the gas generator 12.

According to this third embodiment, the electric machine 30 can drive the generator shaft 14, and therefore the gas generator 12, via the coupling shaft 70. It is thus possible to use the electric machine 30 to start the gas generator 12. Thus, unlike the first and second embodiments, the use of a starter is not necessary. In other words, according to this embodiment, the turboprop 100 comprises a single electric machine, which is the high-power reversible electric machine 30, which can therefore be used in motor mode to drive the main rotor 60, and also for starting the gas generator 12.

Moreover, the second end of the coupling shaft 70 is engaged with the generator shaft 14 by means of a safety disconnection means, in this example a weak section 24, configured to allow disconnection of the coupling shaft 70 with the generator shaft 14 in case of blockage of the gas generator 12, for example during an accidental shutdown or a breakdown thereof.

Indeed, in flight conditions and in case of engine failure leading to the shutdown or even blockage of the gas generator 12, it is possible to retain part of the thrust and improve the pilotability of the aircraft by electrically driving the main rotor 60 by the electric machine 60, after having put the clutch 54 in the coupling position. However, with this architecture comprising the coupling shaft 70, the electric machine 30 would then drive the gas generator 12 at the same time as the main rotor 60, which could represent a significant resistant load.

The weak section 24, disposed between the coupling free wheel 72 and the gas generator 12, makes it possible to avoid this situation by disconnecting the coupling shaft 70 and the generator shaft 14. The electric machine 30 can therefore perform its function of driving the main rotor 60 in case of engine failure, including when the failure leads to a blockage of the generator.

FIG. 6 represents an architecture according to a fourth embodiment, which differs from the third embodiment in that the clutch 54 is replaced by a second free wheel 52 similar to the first embodiment. The second free wheel 52 and the coupling free wheel 72 are mounted in opposition to each other.

The reversible electric machine 30 is able to rotate in a first direction of rotation (by convention, a positive direction) in which it is mechanically coupled to the main rotor 60 via the second free wheel 52, and in a second direction of rotation (by convention, a negative direction), opposite to the first direction of rotation, in which it is mechanically coupled to the gas generator 12 via the coupling free wheel 72 of the coupling shaft 70.

Particularly, the element represented by “−1” in FIG. 6 and the following figures represents gears, for example pinions, allowing the reversal of the direction of rotation. It will thus be understood that when the electric machine 30 rotates in the positive direction, the second free wheel 52 is activated, and the coupling free wheel 72 is deactivated, and when the electric machine 30 rotates in the negative direction, the second free wheel 52 is deactivated, and the coupling free wheel 72 is activated. In this embodiment, the weak section 24 is not necessary.

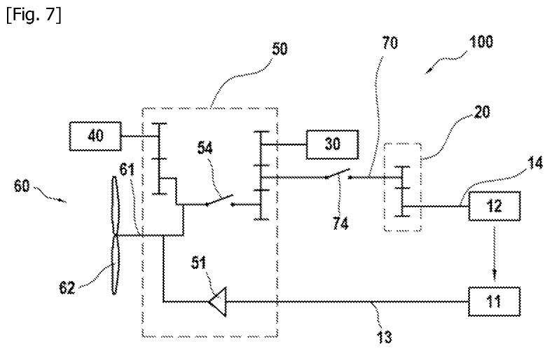

FIG. 7 represents an architecture according to a fifth embodiment, which differs from the third embodiment in that the coupling free wheel 72 is replaced by a second clutch 74, similar to the first clutch 54.

The first and second clutches 54, 74 can be remotely pilotable via a monitoring unit for example, according to the operating phases of the turboprop 100. In the start-up phase for example, the first clutch 54 is placed in the decoupling position and the second clutch 74 is placed in the coupling position. The electric machine 30 can thus drive the gas generator 12 without driving the main rotor 60. Conversely, during 100% electric or hybrid operation, the first clutch 54 is placed in the coupling position and the second clutch 74 is placed in the decoupling position. The electric machine 30 can thus drive the main rotor 60 without driving the gas generator 12.

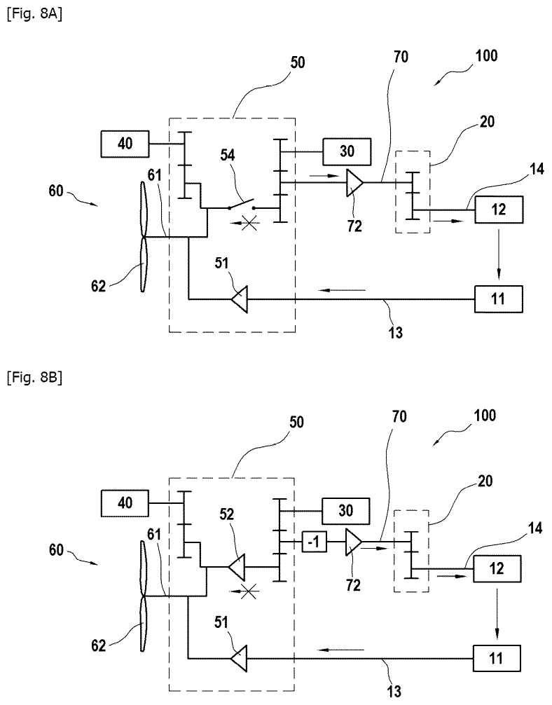

The turboprop architectures according to these different embodiments allow performing a large number of functions, while optimally meeting safety requirements, and also optimizing the arrangement of the members dedicated to lubrication and the mass of the assembly. These different functions are described below with reference to FIGS. 8A to 13, based on the architectures corresponding to the third and fourth embodiments described above.

It will be generally noted that, for the sake of clarity, FIGS. 8A to 13 schematically represent in a functional and simplified manner, the different operating modes of the device, without representing all the details of the elements constituting the turboprop and the different power transmission members. Particularly, the pinions and any speed ratios are not represented. Moreover, it will be noted that in FIGS. 8A to 13 described below, the arrows indicate a direction of power transfer from one member to another, and the crossed-out arrows represent a blockage of the power transfer in the direction indicated by these arrows (when a clutch is open for example).

FIGS. 8A and 8B represent an operating mode allowing the starting of the turboprop 100, based on the architectures corresponding to the third embodiment (FIG. 4) and to the fourth embodiment (FIG. 6) respectively.

In the third embodiment (diagram 8A of FIGS. 8A-8B), during start-up, the clutch 54 is placed in the decoupling position, preventing the transfer of power from the electric machine 30 to the main rotor 60, this power then being transferred to the gas generator 12 via the coupling free wheel 72. When the gas generator 12 becomes autonomous (approximately 50% of its nominal speed), the coupling free wheel 72 disengages, the electric machine 30 stops and the free turbine 11 drives the propeller 62. The free turbine 11 also drives the oil pump 40 during start-up.

In the fourth embodiment (diagram 8B of FIGS. 8A-8B), during start-up, the electric machine 30 is piloted, for example by a monitoring unit (not represented), so as to rotate in the negative direction. Thus, it drives the gas generator 12 via the coupling free wheel 72 which is activated, allowing the start-up of the gas generator 12. The second free wheel 52 is then deactivated. During start-up, the hot gases drive the free turbine 11. The latter, connected to the main rotor 60 via the first free wheel 51, drives the main rotor 60 and in particular the propeller 62. Similarly, when the gas generator 12 becomes autonomous, the coupling free wheel 72 disengages, the electric machine 30 stops, the free turbine 11 thus driving the propeller 62 autonomously. The free turbine 11 also drives the oil pump 40 during start-up.

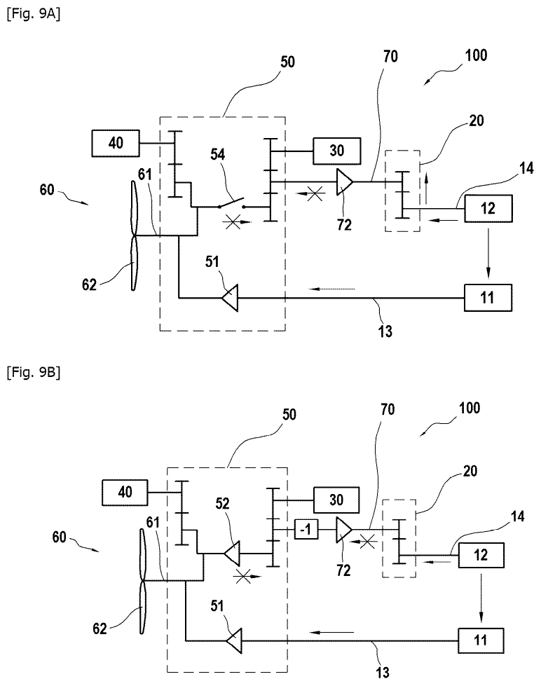

FIGS. 9A-9B represent an operating mode allowing 100% thermal operation of the turboprop 100, based on the architectures corresponding to the third embodiment (FIG. 4) and to the fourth embodiment (FIG. 6) respectively.

In the third embodiment (diagram 9A of FIGS. 9A-9B), during 100% thermal operation, the clutch 54 is placed in the decoupling position, preventing the transfer of power from the main rotor 60 to the electric machine 30, which is stopped. Only the gas generator 12 transfers power to the free turbine 11 and consequently to the main rotor 60. This power cannot be transferred to the electric machine 30 given the orientation of the coupling free wheel 72. The free turbine 11 also drives the oil pump 40 during this operation.

In the fourth embodiment (diagram 9B of FIGS. 9A-9B), during 100% thermal operation, the electric machine 30 is stopped and the second free wheel 52 and the coupling free wheel 72 are both deactivated. Thus, only the gas generator 12 transfers power to the free turbine 11 and consequently to the main rotor 60. The free turbine 11 also drives the oil pump 40 during this operation.

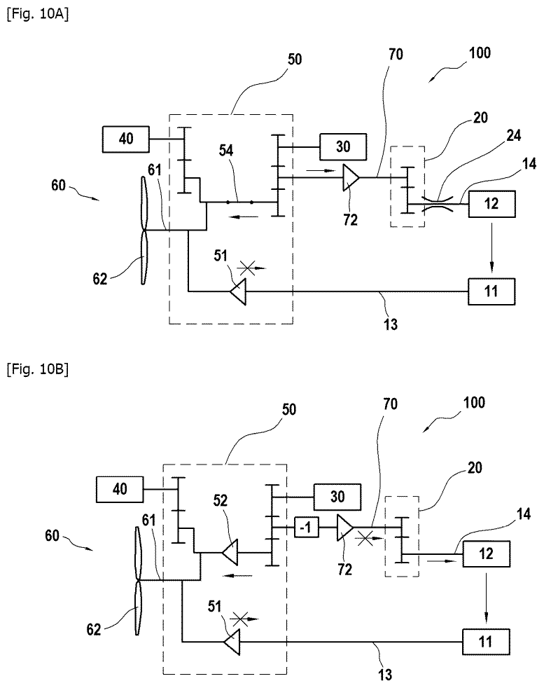

FIGS. 10A-10B represent an operating mode allowing 100% electric operation of the turboprop 100, based on the architectures corresponding to the third embodiment (FIG. 4) and to the fourth embodiment (FIG. 6) respectively.

In the third embodiment (diagram 10A of FIGS. 10A-10B), during 100% electric operation, the clutch 54 is placed in the coupling position, allowing the transfer of power from the electric machine 30 to the main rotor 60. Only the electric machine 30 transfers power to the main rotor 60. In case of blockage of the gas generator 12, the transfer of power from the electric machine 30 to the gas generator 12 can be prevented by breaking of the weak section 24. Furthermore, the transfer of power from the main rotor 60 to the free turbine 11 is prevented thanks to the orientation of the first free wheel 51. The electric machine 30 drives the oil pump 40 during this operation.

In the fourth embodiment (diagram 10B of FIGS. 10A-10B), the electric machine 30 is piloted so as to rotate in the positive direction. Thus, it drives the main rotor 60 via the second free wheel 52 which is activated, allowing the rotation of the propeller 62. The coupling free wheel 72 is then deactivated. Similarly, the transfer of power from the main rotor 60 to the free turbine 11 is prevented thanks to the orientation of the first free wheel 51, and the electric machine 30 drives the oil pump 40 during this operation.

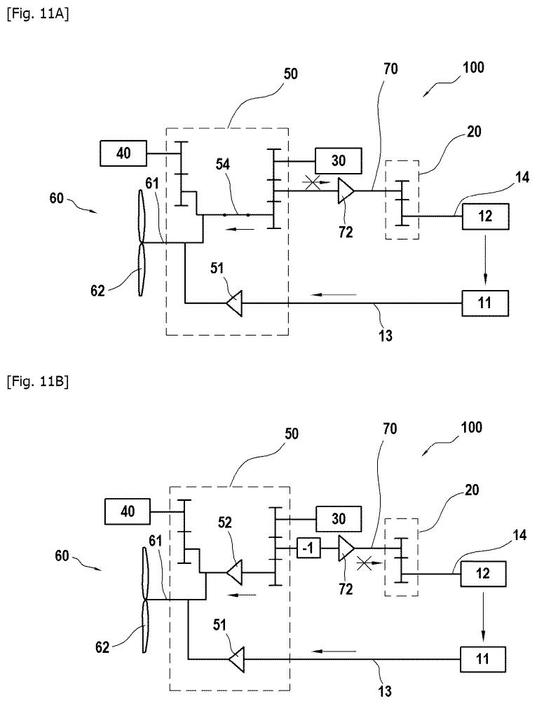

FIGS. 11A-11B represent one operating mode allowing hybrid operation of the turboprop 100, based on the architectures corresponding to the third embodiment (FIG. 4) and to the fourth embodiment (FIG. 6) respectively.

In the third embodiment (diagram 11A of FIGS. 11A-11B), during hybrid operation, the clutch 54 is placed in the coupling position, allowing the transfer of power from the electric machine 30 to the main rotor 60. The electric machine 30 and the free turbine 11 both transfer power to the main rotor 60. The power cannot be transferred from the gas generator 12 to the electric machine 30 given the orientation of the coupling free wheel 72.

In addition, since the gas generator 12 also transfers power to the main rotor 60, the electric machine 30 rotates at a lower speed than the free turbine 11 and the gas generator 12. The electric machine 30 therefore cannot drive the gas generator 12 via the coupling free wheel 72. Particularly, preferably, the electric machine 30 is dimensioned such that the maximum rotation speed of the electric machine 30 in motor mode remains lower than the minimum rotation speed during flight operation of the gas generator 12 (excluding the start-up or shutdown phase). Moreover, the oil pump 40 can be driven by the electric machine 30 and/or the free turbine 11 during this operation.

In the fourth embodiment (diagram 11B of FIGS. 11A-11B), the electric machine 30 is piloted so as to rotate in the positive direction. Thus, it drives the main rotor 60 via the second free wheel 52 which is activated, allowing the rotation of the propeller 62. The coupling free wheel 72 is then deactivated. Thus, the electric machine 30 and the free turbine 11 both transfer power to the main rotor 60. Similarly, the oil pump 40 can be driven by the electric machine 30 and/or the free turbine 11 during this operation.

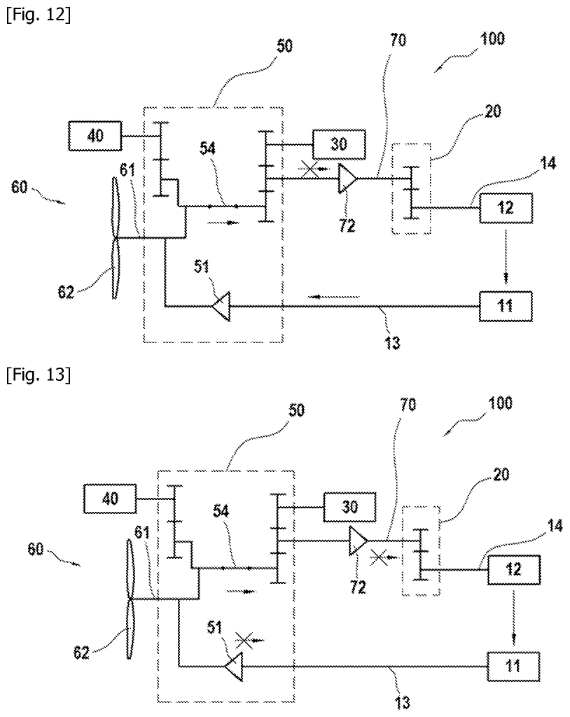

FIG. 12 represents an operating mode allowing electrical generation by the electric machine 30, based on the architecture corresponding to the third embodiment (FIG. 4).

In the third embodiment (FIG. 12), during electrical generation by the electric machine 30, the clutch 54 is placed in the coupling position, allowing the transfer of power from the main rotor 60 to the electric machine 30. Only the gas generator 12 transfers power to the free turbine 11 and consequently to the main rotor 60. The main rotor 60 itself transfers power to the reversible electric machine 30 which operates in generator mode, and which can thus provide electricity to different equipment, to recharge batteries for example.

Power cannot be transferred from the gas generator 12 to the electric machine 30 given the orientation of the coupling free wheel 72. Furthermore, preferably, the electric machine 30 is dimensioned such that the maximum rotation speed of the electric machine 30 in generator mode remains lower than the minimum rotation speed in flight operation of the gas generator 12 (excluding the start-up or shutdown phase), such that the rotation of the electric machine 30 cannot drive the gas generator 12 via the coupling free wheel 72. Moreover, the free turbine 11 also drives the oil pump 40 during this operation.

It will also be noted that the architecture corresponding to the fourth embodiment (FIG. 6) does not allow an operating mode allowing electrical generation by the electric machine 30, given the orientation of the second free wheel 52.

FIG. 13 represents, based on the architecture corresponding to the third embodiment (FIG. 4), an operating mode called “wind turbine” operating mode allowing electrical generation, in which the propeller 62 is driven in rotation by the forward motion of the aircraft, the main rotor 60 thus driving the electric machine 30.

In the third embodiment (FIG. 13), during the so-called “wind turbine” operating mode, the clutch 54 is placed in the coupling position, allowing the transfer of power from the main rotor 60 to the electric machine 30. The gas generator 12 and the free turbine 11 operate in the idle state in flight, and do not transfer power to the main rotor 60 if the rotation speed of the propeller 62 caused by the forward motion of the aircraft is greater than the rotation speed of the free turbine 11. Conversely, if the propeller 62 does not recover sufficient power from the forward motion of the aircraft, it can be driven by the free turbine 11 operating in the idle state. The power cannot be transferred from the gas generator 12 to the electric machine 30 given the orientation of the coupling free wheel 72. In addition, as long as the rotation speed of the electric machine 30 remains lower than that of the gas generator 12, the electric machine 30 does not drive the gas generator 12, the coupling free wheel 72 not being clutched.

Moreover, the transfer of power from the main rotor 60 to the free turbine 11 is prevented thanks to the orientation of the first free wheel 51. Thus, even when the gas generator 12 and the free turbine 11 are operating in the idle state in flight, the rotation of the propeller 62 generated by the forward motion of the aircraft allows the actuation of the main rotor 60, itself thus transferring power to the reversible electric machine 30 which operates in generator mode. The main rotor 60 also drives the oil pump 40 during this operation.

It should also be noted that the architecture corresponding to the fourth embodiment (FIG. 6) does not allow an operating mode called “wind turbine” operating mode allowing electrical generation by the electric machine 30, given the orientation of the second free wheel 52.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

1. A hybrid turboprop for an aircraft, comprising a gas generator carried by a generator shaft, a free turbine carried by a turbine shaft and driven in rotation by a gas stream generated by the gas generator, the turbine shaft being engaged with a main rotor via a transmission unit comprising a first free wheel oriented such that the main rotor cannot drive the free turbine, a reversible electric machine able to be engaged with the main rotor via the transmission unit to drive the main rotor-during an electric or hybrid operating mode, the turboprop comprising a single oil pump engaged with the transmission unit so as to be selectively driven by the turbine shaft or by the electric machine depending on the operating mode of the turboprop.

2. The hybrid turboprop according to claim 1, wherein the electric machine is engaged with the main rotor via a second free wheel of the transmission unit, the second free wheel being oriented such that the main rotor cannot drive the electric machine.

3. The hybrid turboprop according to claim 1, wherein the electric machine is able to be engaged with the main rotor via a reversible coupling means movable between a coupling position in which the electric machine can drive the main rotor during operation in motor mode or be driven by the main rotor or the free turbine during operation in generator mode, and a decoupling position in which the electric machine is decoupled from the main rotor.

4. The hybrid turboprop according to claim 3, wherein the reversible coupling means is a clutch.

5. The hybrid turboprop according to claim 3, comprising a coupling shaft having a first end engaged with the transmission unit, and a second end engaged with the generator shaft.

6. The hybrid turboprop according to claim 5, wherein the coupling shaft comprises a coupling free wheel oriented such that the gas generator cannot drive the electric machine.

7. The hybrid turboprop according to claim 5, wherein the second end of the coupling shaft is engaged with the generator shaft via a safety disconnection means configured to allow disconnection of the coupling shaft with the generator shaft in case of partial or total blockage of the gas generator.

8. The hybrid turboprop according to claim 2, comprising a coupling shaft having a first end engaged with the transmission unit, and a second end engaged with the generator shaft, the coupling shaft comprising a coupling free wheel oriented such that the gas generator cannot drive the electric machine, the second free wheel being configured to be activated when the electric machine rotates in a first direction of rotation, and the coupling free wheel being configured to be activated when the electric machine rotates in a second direction of rotation opposite to the first direction of rotation.

9. The hybrid turboprop according to claim 5, wherein the reversible coupling means is a first reversible coupling means, the second end of the coupling shaft being engaged with the generator shaft via a second reversible coupling means movable between a coupling position in which the electric machine and the gas generator are coupled, and a decoupling position in which the electric machine and the gas generator are decoupled.

10. The hybrid turboprop according to claim 5, wherein the generator shaft is engaged with an accessory gearbox distinct from the transmission unit, the second end of the coupling shaft being engaged with the accessory gearbox.

11. An aircraft comprising a hybrid turboprop-according to claim 1, the aircraft being a propeller plane.
